(19) United States
(12) Patent Application Publication
(10) Pub. No.: US 2014/0160054 A1
(43) Pub. Date: Jun. 12, 2014

(54) ANCHOR-DRAG TOUCH SYMBOL RECOGNITION

(71) Applicant: QUALCOMM INCORPORATED, San Diego, CA (US)

(72) Inventors: Khosro Rabii, San Diego, CA (US); Dat Tien Pham, San Diego, CA (US)

(73) Assignee: QUALCOMM INCORPORATED, San Diego, CA (US)

(21) Appl. No.: 13/707,206

(22) Filed: Dec. 6, 2012

(51) Int. Cl. G06F 3/044

(52) U.S. Cl. CPC G06F 3/044
USPC 345/174; 345/173

(57) ABSTRACT

Described herein are methods and devices that employ a predefined class of anchor-drag touches to minimize host processor use in a mobile computing device. As described, detecting anchor-drag touch gestures enables the touch screen controller to handle a large portion of touch processing, even in mobile devices with larger displays. A first touch establishes an anchor area, from which a drag area is calculated, and a second touch within the drag area provides a command to the device. Some embodiments may limit subsequent touch processing to the identified drag area.

### TECHNICAL FIELD

The present embodiments relate to touch screen devices, and in particular, to methods and apparatus for the detection of anchor-drag multitouch gestures.

### BACKGROUND

Advances in technology have resulted in smaller and more powerful computing devices. For example, there currently exist a variety of portable computing devices, including wireless computing devices such as wireless telephones, personal digital assistants (PDAs), and tablet computers that are small, lightweight, and easily carried by users. In order to simplify user interfaces and to avoid pushbuttons and complex menu systems, such portable computing devices may use touch screen displays that detect user gestures on the touch screen and translate the detected gestures into commands to be performed by the device. Such gestures may be performed using one or more fingers or a stylus type pointing implement. Multi-touch screens (touch screens having multi-touch capability) are designed to recognize and track several simultaneous touches. For example, when a user moves two fingers on a screen, information indicating touch/movement for both fingers is provided by a multi-touch screen.

One drawback of implementing multi-touch technology on portable computing devices is the processing overhead typically required for recognizing multi-touch. Processing overhead measures the total amount of work the central processing unit (CPU) of the device can perform and the percentage of that total capacity which is used by individual computing tasks, such as touch detection. In total, these tasks must require less than the processor's overall capacity. Simple touch gestures may typically be handled by a touchscreen controller, which is a separate processor associated with the touch screen, but more complex touch gestures require the use of a secondary processor, often the mobile device's CPU, to process large amounts of touch data. Typically, large amounts of touch data must be processed to determine the nature of the touch, sometimes only to conclude that a touch was a “false positive,” consuming large amounts of CPU capacity and device power. The processing overhead required for complex touch recognition may require a large percentage of the overall CPU capacity, impairing device performance.

The current generation of mobile processors is not well adapted to deal with increasing touch complexity and corresponding CPU overhead, especially in conjunction with the many other common high performance uses of mobile devices. Increasing the size of the mobile processor core or cache delivers performance increases only up to a certain level, beyond which heat dissipation issues make any further increase in core and cache size impractical. Overall processing capacity is further limited by the smaller size of many mobile devices, which limits the number of processors that can be included in the device. Additionally, because mobile computing devices are generally battery-powered, high performance uses also shortens battery life.

Despite mobile processing limitations, many common mobile applications such as maps, games, email clients, web browsers, etc., are making increasingly complex use of touch recognition. Further, touch processing complexity increases proportional to touch-node capacity, which in turn increases proportional to display size. Therefore, because there is a trend in many portable computing devices toward increasing display size and touch complexity, touch processing is increasingly reducing device performance and threatening battery life. Further, user interaction with a device through touch events is highly sensitive to latency, and user experience can suffer from low throughput interfaces between the touchscreen panel and the host processor resulting in processing delay and response lag.

### SUMMARY

According to an embodiment, a touch processing system configured to recognize multitouch gestures comprises a touch panel; a touch detection module configured to capture a first touch event and a second touch event on the touch panel; and a processing module configured to determine if the second touch event is within a predefined boundary area from the first touch event, and discard the touch event if it is outside of the predefined boundary, the processing module further configured to track a position of a touch event within the predefined boundary and activate a predetermined object drag process based on the position of the touch event.

Another embodiment comprises a method of implementing a multitouch recognition function on a computing device equipped with a touch panel, the method comprising detecting a first touch event at a first location; defining a base area on the touchscreen display based at least in part on the first location; determining a drag area of the touch panel based at least in part on a predetermined geometric boundary in relation to the base area; temporarily limiting subsequent touch processing on the touch panel to the drag area; and detecting a second touch event within the drag area. In some embodiments, the first touch is made by a first finger of a hand and the second touch is made by a second finger of the hand, and determining a drag area further comprises estimating a Euclidean distance and angle between the first finger and the second finger.

### BRIEF DESCRIPTION OF THE DRAWINGS

The disclosed aspects will hereinafter be described in conjunction with the drawings, provided to illustrate and not to limit the disclosed aspects, wherein like designations denote like elements.

FIG. 1 illustrates an embodiment of an anchor drag touch system;

FIG. 2 illustrates an embodiment of a class of anchor-drag touch symbols;

FIG. 3 illustrates an embodiment of a mobile computing device equipped with touch processing;

FIG. 4 illustrates one embodiment of an anchor-drag gesture recognition process;

FIG. 5 illustrates an embodiment of an anchor-drag touch processing technique; and

FIG. 6 illustrates another embodiment of an anchor-drag touch processing technique where processing is limited to a drag area.

### DETAILED DESCRIPTION

The gesture recognition techniques described herein define an anchor-drag touch class to enable touch symbol recognition with nominal processing overhead, even in large touch screen panels. A user's first touch on a touch panel, for example with a thumb of one hand, may be used to define an area termed the “base area.” This finger may be termed the base finger. From the location of this base area, a potential “drag area” may be estimated in which the user might use a second finger, for example the index finger of that same hand, to make a second touch on the touch panel. This touch may be a drag touch in one of many unique shapes, each of which may be associated with a specific command. Because the drag area occupies only a portion of the larger touch panel, the touch processing overhead required to detect the second touch is minimized.

The anchor-drag touch class gestures are easily distinguishable, enabling reliable detection and further reducing processing overhead which is typically required to conduct de-noising and filtering over the touch panel to identify “false positives,” or unintentional touches. A further advantage is that, for applications that require a user specify a display region such as in a photo or video editor, the anchor-drag touch class provides an organic method for the user to select a display region.

Implementations disclosed herein provide systems, methods and apparatus for recognizing an anchor-drag touch class of multitouch gestures. The anchor-drag techniques described are implemented to input information onto a touchscreen while reducing power usage and decreasing latency and processing overhead in touchscreen technologies. As described in more detail below, the touchscreen system detects a first “anchor” position that may be set, in one example, by a user's thumb. Once the anchor position has been set, the system limits the potential area wherein further touch detection will be made to that area that is accessible by another finger of the user's same hand, for instance the user's forefinger. By using single-hand touch coordination and recognition of symbols created by the user's forefinger, the system enables touchscreen systems using generic touchscreen controllers (or touchscreen processors) to easily process coordinated touches without the use of host processing, even in large touchscreen display panels. By reducing the need for a device's host processor, such gesture recognition techniques may extend the battery life of mobile touchscreen devices as well as enhance user experience by reducing latency.

Embodiments may be implemented in hardware, software, firmware, or any combination thereof. Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

### I. DEVICE OVERVIEW

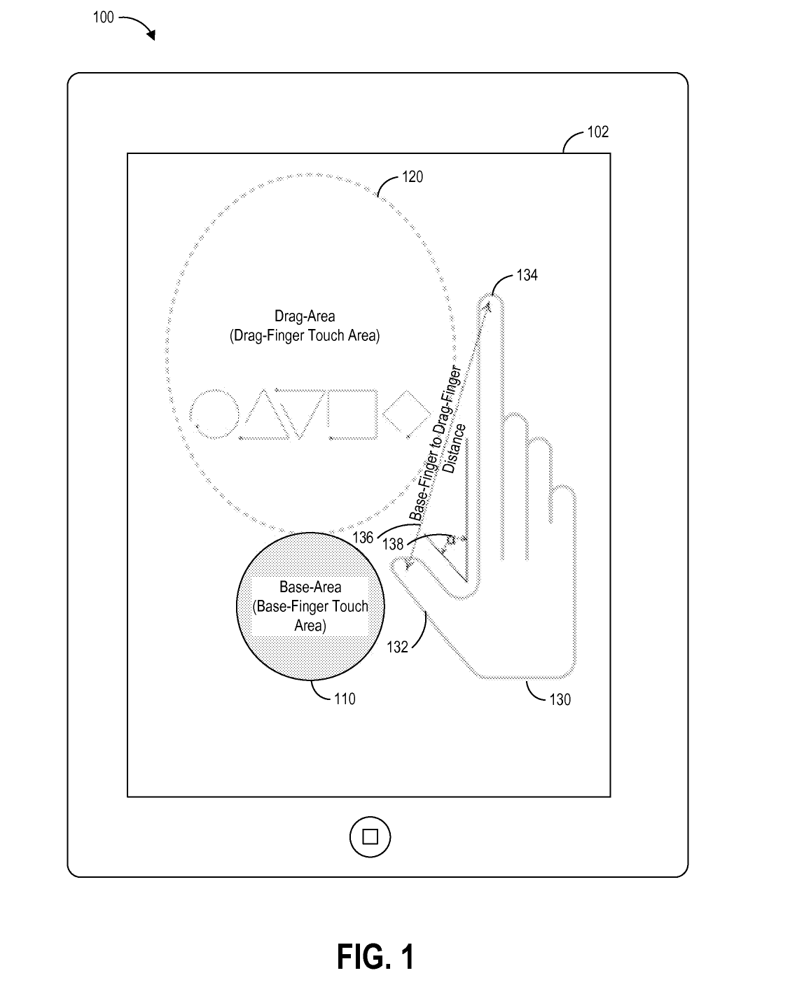

Referring now to FIG. 1, an exemplary touch sensitive mobile computing device configured to recognize anchor-drag gestures will now be described in greater detail. As shown in FIG. 1, the mobile computing device 100 includes a touch sensitive display 102. Within the touch screen display, a first finger 132 and second finger 134 of a user's hand 130 define a base area 110 and drag area 120, respectively. The first finger 132 and second finger 134 are separated by a distance 136 and form an angle 138.

Although the mobile computing device 100 shown is a tablet computer, it will be understood by those skilled in the art that this is for purposes of illustration only and that the touch sensitive display 102 may be employed in a variety of mobile computing device such as image capture devices, mobile communications devices such as smart phones, electronic reader devices (e.g., e-readers), game consoles, portable media players, personal digital assistants, portable medical devices, or laptops. Further, although display 102 is discussed herein as being incorporated into mobile computing devices, such touch screen technology as well as the described gesture recognition techniques may be employed on stationary computing devices as well, such as desktop computers, large display screens, or workstations.

Touch sensitive display 102 comprises a touch screen. A touch screen can detect the presence and location of a touch within a display area as well as display visual information in the display area. There are several touch screen technologies currently available which support multi-touch input, including capacitive, resistive, and optical touch sensing using cameras. Capacitive technology operates by sensing the electric current from a user's finger, which interrupts the electrostatic field of the touch screen, resulting in a detected touch. In some implementations, a touchscreen can include a projected capacitive touch (PCT) sensor arranged over a display. The PCT sensor can include an array of capacitors formed by a number of sensor electrodes in the form of overlapping electrodes, such as row electrodes and column electrodes that are arranged in a grid pattern. Resistive technology detects a touch through pressure sensing, which occurs when a finger or stylus touches the touch screen and two conductive layers come into contact with one another and close an electrical circuit.

Certain embodiments of the device may employ a multi-touch analog resistive system (MARS or AMR). Optical touch sensing requires no pressure to operate, detecting movement of objects near the touch screen with a plurality of optical sensors mounted on or near the surface of the touch screen. Surface acoustic wave (SAW) touch screens rely on the absorption of sound waves to detect a touch, so either a finger or gloved finger will work for touch detection. However, a touch by a small, hard stylus will not be detected, so SAW touch screens usually require a special soft-tipped stylus. Display 102 may incorporate any of these technologies as well as other known touch sensitive technologies.

As depicted in below Table 1, touch technology includes a diverse set of different technologies. So long as the underlying touch technology can be used to sense required touch resolution (pitch) accurately, the proposed Anchor-Drag systems described herein can be recognized and processed efficiently.

TABLE 1
Touch Technologies

| Display | | | Touch Technology Specification | | | |
|---|---|---|---|---|---|---|
| Transparency | Sensor | Touch | Market | Touch Technology | | Detection |
| Requirement | Location | Resolution | Status | Type | | Mechanism |
| Without | Edge- | Low | | Acoustic Pulse | | Bending |
| Transparent | Conductors | | | Recognition (APR) | | waves |
| Conductor | | Low | | Dispersive Signal | | |
| | | | | Technology (DST) | | |
| | Without | Low | Mainstream | Surface Acoustic Wave | | Time Delay |
| | Edge- | | | (SAW) | | |
| | Conductors | Low | Mainstream | Traditional Infrared | | Absence of |
| | | | | (IR/NIR) | | Light |
| | | Low | | Waveguide Infrared | | Presence of |
| | | | | | | Light |
| | | Low | Emerging | Optical | | Absence of |
| | | | | | | Light |
| | | Low | | Force-Sensing | | Pressure |
| | | HIGH | | Vision-Recognition | | Visual |
| | | | | | | Object |
| | Embedded | HIGH | Emerging | In-Cell | | Voltage- |
| | | | | | | Sensing |
| | | | | | | Light- |
| | | | | | | Sensing |
| | | | | | | Self- |
| | | | | | | Capacitive |
| | | | | | | Pressed |
| | | | | | | Capacitive |
| | | | | On-Cell | | Projected- |
| | | | | | | Capacitive |
| | | | | | | Analog- |
| | | | | | | Resistive |
| | | | | Out-Cell | | |
| | | | | Hybrid In-Cell/Out-Cell | | |
| With | Continuous | Low | Mainstream | Surface Capacitive | | Current |
| Transparent | | Low | Mainstream | Analog Resistive | | Voltage |
| Conductor | Discrete/ | Low | Emerging | Analog Multitouch | | |
| (ITO) | Sampled/ | | | Resistive (AMR) | | |
| | Patterned | HIGH | Mainstream | Projected | Absolute- | Capacitance |
| | | | | Capacitive | Capacitive | Change |
| | | | | (PCT/ | (Self | |
| | | | | Pro-CAP) | Capacitive) | |
| | | | | | Trans- | |
| | | | | | Capacitive | |
| | | | | | (Mutual | |
| | | | | | Capacitive) | |

Within the area of display 102, a first touch from a user defines the base area 110. The first touch may be performed with a first finger 132 of the user's hand 130, for example by a thumb. The device 100 may use the distance 136 between the first finger 132 and a second finger 134, for example an index finger of the same hand 130, as well as an angle 138 formed between the two fingers 132, 134 to estimate the drag area 120. In some embodiments, the distance 136 and the angle 138 may be based on a likely size of the user's hand, for example by using an average distance 136 and angle 138 of a plurality of users' hands. In other embodiments, the distance 136 and angle 138 may be based specifically on the size of the user's hand 130, for instance by having the user place thumb and forefinger on the device during a measuring process, or by gathering data about the user's hand size during previous interactions with the touch display 102. In certain embodiments, angle 138 may be a Euclidean angle.

Once the drag area 120 is established, the device 100 may discard any touch data that does not occur within the drag area 120 for a certain period of time. The device 100 may also discard touch data within the drag area 120 which is not a recognized drag symbol, as discussed in more detail below. In some embodiments, once a drag touch is recognized, the device 100 may establish the base area 110 as permanent or semi-permanent so that only subsequent touch data within the drag area 120 will be processed. If no drag touch is recognized within drag area 120 after a predetermined amount of time, certain embodiments may open up touch processing once again to the entire display 102, and may require a new drag touch to set a new base area 110.

As illustrated, the anchor-drag gesture is carried out by two fingers 132,134 of a single hand 130 of a user performing sequential touches. However, in other embodiments, the anchor-drag gesture may be performed in a variety of other ways, for example two sequential touches by one finger or a stylus, two sequential touches by two fingers of two hands, or even by a single touch. In such embodiments, the drag area may be calculated using a different method than Euclidean distance and angle. For instance, a drag area may be displayed to the user in a predetermined area of the screen after being initiated by a base touch.

By defining base area 110, the device 100 is able to limit subsequent touch processing to the drag area 120. Because drag area 120 comprises a boundary which is a subset of the area of the touch display 102, the anchor-drag technique targets an area from which to receive touch data which is smaller than the touch panel, reducing touch processing overhead. The combination of a base area 110 and drag area 120 further reduces processing overhead by enabling the touchscreen system to skip constant de-noising and filtering, as the anchored-drag gestures are easily distinguishable from unintentional touches to the touch display 102. In some embodiments, the drag area will be set according to Euclidean distances between the touches.

### II. ANCHOR-DRAG TOUCH CLASS

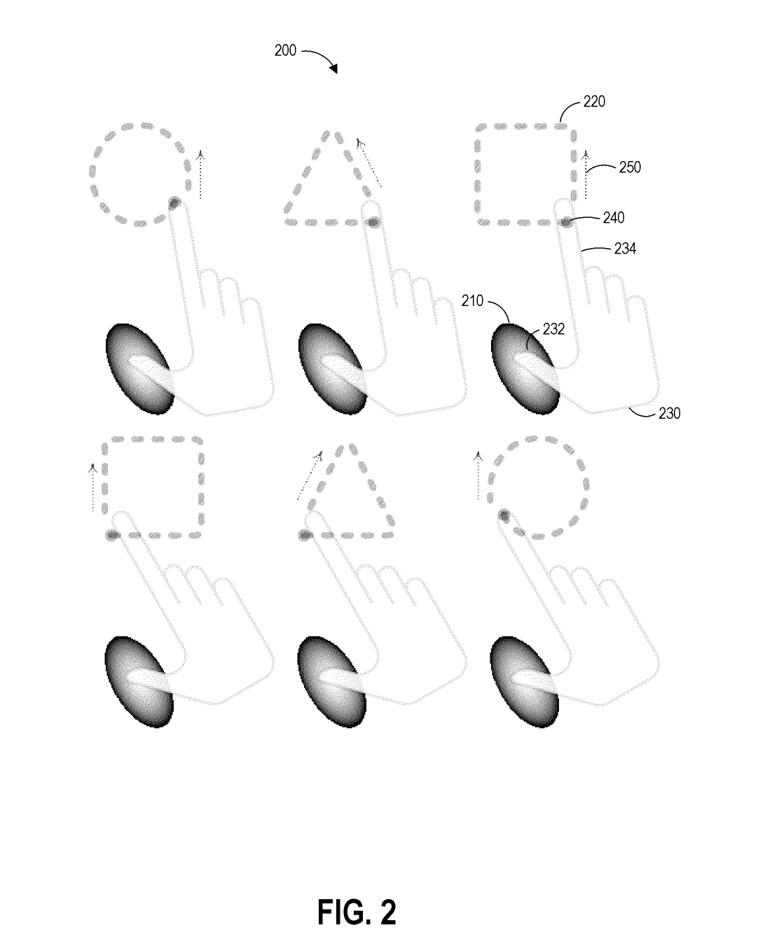

As illustrated in FIG. 2, an anchor-drag touch class 200 comprises a set of single-hand coordinated touch gestures for use with touchscreen devices. Each gesture comprises an anchor touch and a drag touch, the anchor touch corresponding to a base area 210 on the touch screen, and the drag touch corresponding to a drag area wherein a specific geometric shape 220 can be entered by the user.

A user may position a first finger 232 of a hand 230, for example a thumb, to perform the anchor touch within the base area 210. In some embodiments, the base area 210 may be a predefined area displayed to the user for the purpose of indicating an area in which the anchor touch will be recognized. In other embodiments, the base area 210 may be defined anywhere on the touch screen where the touchscreen device recognizes an anchor touch. While maintaining the anchor touch, the user moves a second finger 234, for example the index finger of the same hand 230, along the surface of the touchscreen to perform the drag touch. The drag touch may be one shape 220 of a set of geometric shapes, and each shape 220 may be recognized by the device as being associated with a unique set of information or with a function for device control. Although the anchor-drag gestures are illustrated as being accomplished by a single hand, it is possible that the anchor touch and drag touch could be performed with the use of both hands.

Some embodiments of the anchor-drag touch class 200 may, in addition to recognizing a plurality of shapes 220, recognize a variety of characteristics of how the user creates the shape, and may associate a different function or set of information with the shape depending upon the characteristics. For example, when the user performs the drag touch to generate shape 220, the starting point 240 of the drag touch and direction 250 in which the shape is drawn may determine the function or information associated with the shape. Other characteristics not illustrated, such as pressure, speed, or size of the shape may also be used to determine what function or information is associated with the shape.

In some of the present embodiments, once an anchor-drag touch is recognized, the base area 210 may be set such that subsequent touch commands can only be assumed applicable to the drag area. In other embodiments, after an anchor-drag touch has been recognized the anchor touch may be used to define a new set of more complex gestures, such as by varying the push level of the base finger 232 or using the base finger 232 to perform an additional touch within the base area 210. The additional touch may be a tap or another drag touch indicating a new or additional function for the device to perform.

### III. SYSTEM COMPONENTS

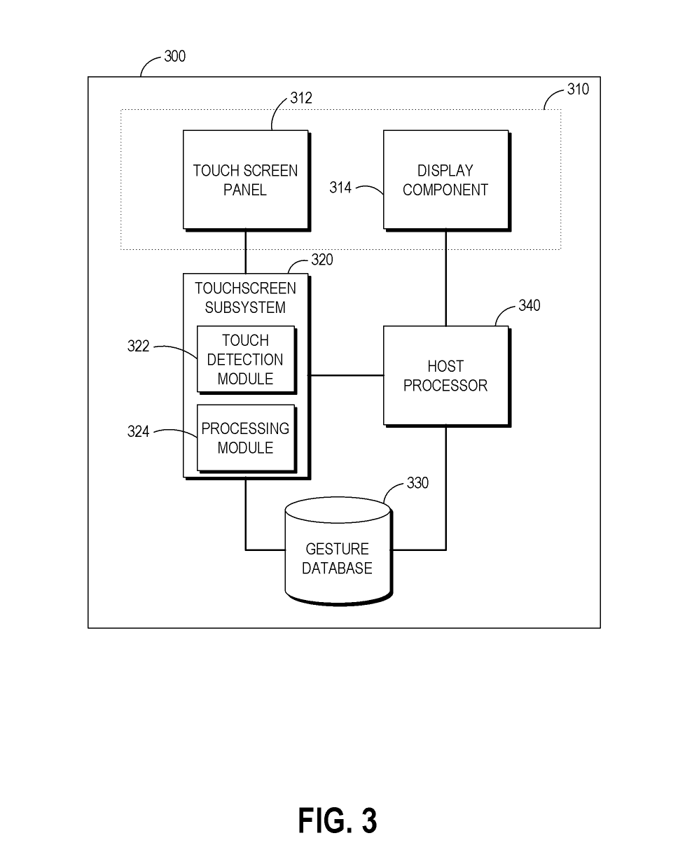

FIG. 3 illustrates a block diagram of a mobile computing device 300 in accordance with one embodiment of the present disclosure which could perform the anchor-drag touch recognition techniques described above with respect to FIGS. 1 and 2. The device 300 comprises a display 310, a touch screen subsystem 320, a gesture database 330 and a host processor 340. The illustrated embodiment is not meant to be limitative and device 300 may include a variety of other components as required for other functions.

The display 310 of device 300 may include a touch screen panel 312 and a display component 314. Certain embodiments of display component 314 may be any flat panel display technology, such as an LED, LCD, plasma, or projection screen. Display component 314 may be coupled to the host processor 340 for receiving information for visual display to a user. Such information includes, but is not limited to, visual representations of files stored in a memory of device 300, software applications installed on device 300, user interfaces, and network-accessible content objects. In some embodiments, display component 314 may also be used to display a boundary or other depiction of the base area 110, 210, drag shape 220, or drag area 120 discussed above with respect to FIGS. 1 and 2.

Touch screen panel 312 may employ one or a combination of many touch sensing technologies, for instance capacitive, resistive, surface acoustic wave, or optical touch sensing. To accommodate recognition of the anchor-drag touch class described herein, the touch sensing technology may support multitouch gestures. In some embodiments, touch screen panel 312 may overlay or be positioned over display component 314 such that visibility of the display component 314 is not impaired. In other embodiments, the touch screen panel 312 and display component 314 may be integrated into a single panel or surface. The touch screen panel 312 may be configured to cooperate with display component 314 such that a user touch on the touch screen panel 312 is associated with a portion of the content displayed on display component 314 corresponding to the location of the touch on touch screen panel 312. Display component may also be configured to respond to a user touch on the touch screen panel 312 by displaying, for a limited time, a visual representation of the touch, for example a drag shape 220 as described in FIG. 2.

Touch screen panel 312 may be coupled to a touch screen subsystem 320, the touch screen subsystem 320 comprising a touch detection module 322 and a processing module 324. The touch screen panel 312 may cooperate with touch screen subsystem 320 to enable device 300 to sense the location, pressure, direction and/or shape of a user touch or touches on display 310. The touch detection module 322 may include instructions that when executed can scan the area of the touch screen panel 312 for touch events and to provide the coordinates of touch events to the processing module 324. In some embodiments, the touch detection module 322 may be an analog touch screen front end module comprising a plurality of software drivers.

The processing module 324 of the touch screen subsystem 320 may be configured to analyze touch events and to communicate touch data to host processor 340. The processing module 324 may, in some embodiments, include instructions that when executed act as a touch screen controller (TSC). The specific type of TSC employed will depend upon the type of touch technology used in panel 312. The processing module 324 may be configured to start up when the touch detection module 322 indicates that a user has touched touch screen panel 312 and to power down after release of the touch. This feature may be useful for power conservation in battery-powered devices such as mobile computing device 300.

Processing module 324 may be configured to perform filtering on touch event data received from touch detection module. For example, in a display 310 where the touch screen panel 312 is placed on top of a display component 314 comprising and LCD screen, the LCD screen may contribute noise to the coordinate position measurement of the touch event. This noise is a combination of impulse noise and Gaussian noise. The processing module 324 may be configured with median and averaging filters to reduce this noise. Instead of using only a single sample for the coordinate measurement of the touch event, the processing module 324 may be programmed to instruct the touch detection module 322 to provide two, four, eight, or 16 samples. These samples may then be sorted, median filtered, and averaged to give a lower noise, more accurate result of the touch coordinates.

The processing module 324 is a processor specifically configured for use with the touch screen subsystem 320, while host processor 340 may be configured to handle the general processing requirements of device 300. The processing module 324 and the host processor 340 may be in communication with each other as well as a gesture data store 330. For example, processing module 324 may determine that a sequence of touch events matches a pattern identified in gesture data store 330 as an anchor-drag touch gesture. Processing module 324 may retrieve a function or other information associated with the recognized gesture from gesture data store 330 and send instructions to host processor 340 to carry out the function or display the information on display 310.

When the touchscreen subsystem 320 detects a touch or sequence of touches that is recognized as an anchor-drag gesture, processing module 324 may limit subsequent touch processing to a drag area, such as the predicted drag area 120 described in FIG. 1. Touch events outside of the predicted drag area 120 may either be discarded or, in some embodiments which limit scanning as well as touch processing to the drag area, not sensed. The anchor-drag touch class described in this disclosure enables the processing module 324 to process touch data with less reliance on the host processor 340 than in typical touch processing architectures by creating an easily detectable set of touch gestures and by allowing the processing module 324 to limit processing to a subset of touch screen panel 312.

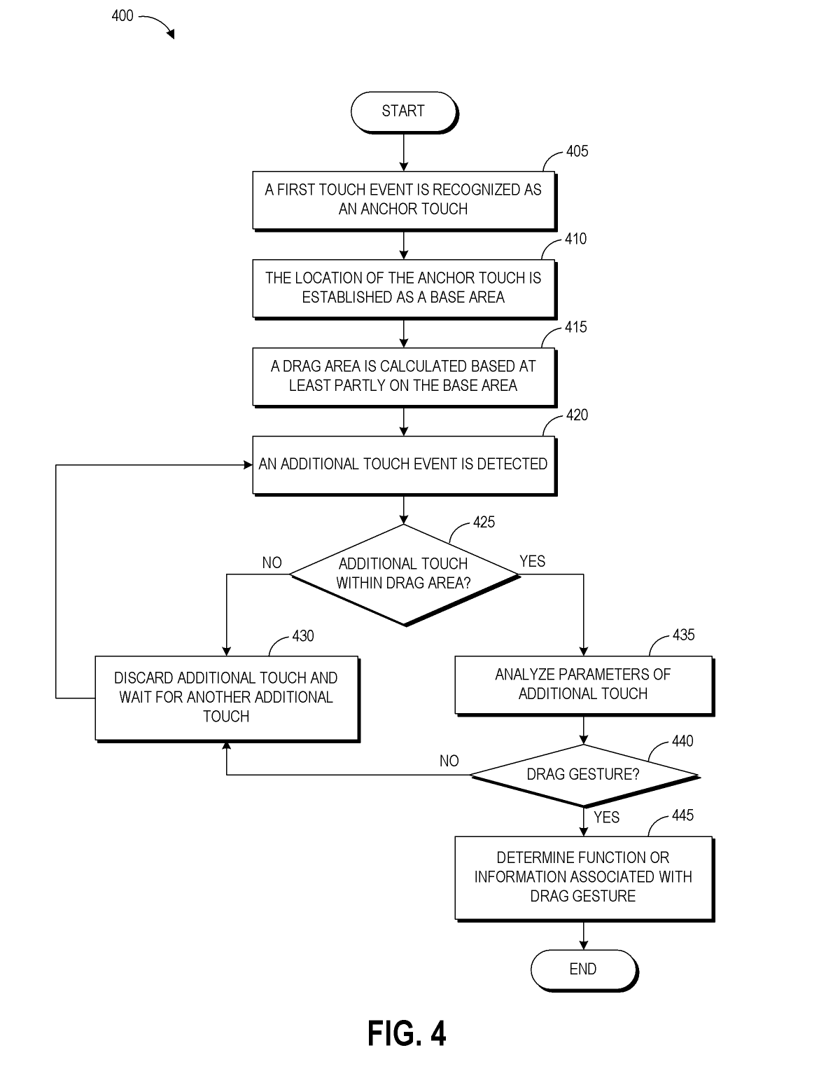

### IV. ANCHOR-DRAG TOUCH RECOGNITION (FIG. 4)

FIG. 4 illustrates one embodiment of a process 400 that may be used to determine whether a touch event on a touch screen is an anchor-drag touch. The anchor-drag touch may be one illustrated in anchor-drag touch class 200 described above with respect to FIG. 2, and may be executed by the touch screen subsystem 320 of FIG. 3.

The process 400 begins at block 405 when a first touch event on a touch screen is identified and recognized as an anchor touch. The tap may be detected as an anchor by its persistence and/or permanence on the touchscreen. The process 400 then moves to block 410, where the location of the anchor touch is established as the base area. In some embodiments, the base area may be defined by a single point, for example an x-y coordinate pair located at the approximate center of the anchor touch. In other embodiments, the base area may be defined by a boundary, such as the boundary around the anchor touch.

After establishing a base area, the process 400 transitions to block 415 where a drag area is calculated based at least in part on the location of the base area. Other factors influencing the calculation of the drag area may be, in certain embodiments, an estimated or actual distance from an end of a user's thumb to an end of the user's index finger of the same hand. This distance may represent the distance from fingertip to fingertip either when the user's hand is fully extended or when the user's fingers are curved to interact with the touch screen. As discussed above, this distance may be based on an average user hand size or may be based upon the actual user's hand size as determined by a measuring process or a learning algorithm which tracks gesture data over time. Another factor may be a Euclidean angle formed between the user's thumb and index finger. The drag area calculated by process 400 may be represented by a boundary of varying size, depending upon the size of drag gestures which the process 400 seeks to recognize and the precision with which a user will “draw” the drag gesture.

The process 400 transitions to block 420 where an additional touch event is detected. This moves the process 400 to decision block 425, where it is determined whether the additional touch was within the calculated drag area. If the touch was not within the drag area, the process 400 moves to block 430 where the touch data is discarded, and then the process 400 loops back to block 420 to detect an additional touch event. If the additional touch is within the drag area, the process 400 transitions to block 435 to analyze the parameters of the touch. Such parameters may include for example, the pressure, direction, shape, start point, end point, and/or duration of the additional touch event.

After determining the parameters of the additional touch, the process 400 moves to decision block 440 to determine whether the parameters match the parameters of the drag gestures defined in the anchor drag touch class 200. If no match is found, the process 400 moves to block 430 where the touch data is discarded, and then the process 400 loops back to block 420 to detect an additional touch event. If a drag gesture is found which has parameters matching those of the additional touch, the process 400 transitions to block 445 where a function or set of information associated with the drag touch is retrieved. This may be accomplished in certain embodiments by the processing module 324 accessing touch gesture data store 330. In some embodiments, the drag touch must occur while the anchor touch is still in place on the touch screen. In other embodiments, the user may release the anchor touch before performing the drag gesture. In yet other embodiments, the user may simultaneously perform the anchor touch and the associated drag gesture and both touch events may be processed and analyzed together.

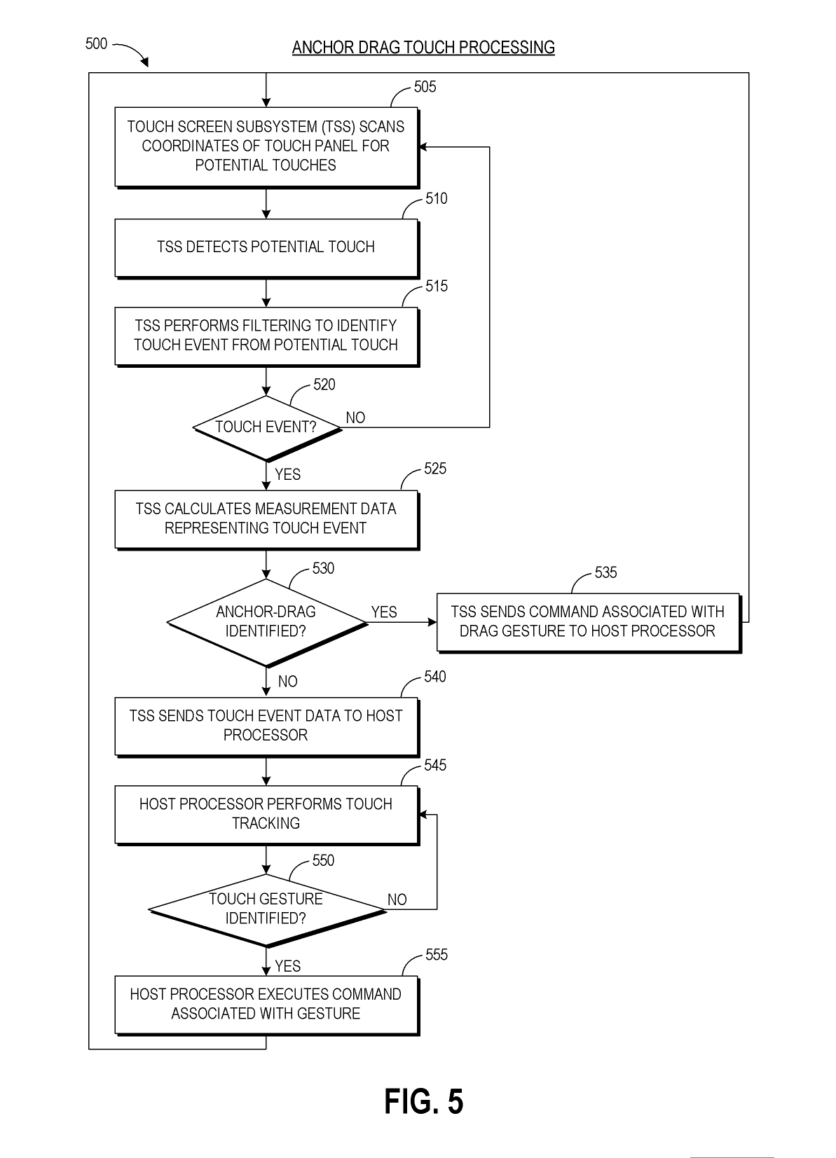

### V. ANCHOR-DRAG TOUCH PROCESSING (FIG. 5)

FIG. 5 illustrates one example of a process 500 that may be used by the touch screen subsystem 320 and host processor 340 of FIG. 3 to process data associated with touch events. As will be apparent, numerous variations and additions to this process are possible, a few of which are discussed below.

The process 500 begins at block 505 where, when in an idle mode, a touch screen subsystem repeatedly scans a touch panel for a user touch. This may be implemented by the touch screen subsystem 320 and touch sensing panel 312 of FIG. 3. In some embodiments, the touch panel may be made up of rows and columns, with each row and column being connected to at least one conductive wire coupled to the touch screen subsystem 320. To perform the step of block 505, the touch screen subsystem 320 may turn on one row and one column at a time to determine whether a user touch is occurring in the intersection of that row and column. After scanning all row and column combinations, the touch screen subsystem 320 may begin the scanning process over. In certain embodiments this scanning process may be carried out by touch detection module 322.

When touch screen subsystem 320 determines that a touch event has occurred at a scanned point, the process 500 moves to block 510. In multitouch applications such as the anchor-drag gesture class described herein, touch detection module 322 may be configured to detect at least a first touch event and a second touch event during the touch detection step 510. Detection of a touch at block 510 may activate the processing module 324. The process 500 then moves to block 515, wherein the touch screen subsystem 320 performs filtering to identify whether the touch event was an intentional touch or an accidental touch, also known as a “false positive.” This may be accomplished by processing module 324 in a manner similar to the noise filtering techniques described above with respect to FIG. 3.

After filtering is completed at block 515, the process 500 transitions to decision block 520 to determine whether a touch event was detected. If the touch screen subsystem 320 determines at decision block 420 that the filtered data does not represent an intentional touch event, the process cycles back to block 505 to repeat the idle mode scanning process. Certain embodiments may power off the touch processing module 324 during idle mode. In some embodiments adapted to detect multitouch gestures, the scanning process of block 505 may be executed continuously throughout the other steps of the process in order to detect additional touch events. In such embodiments, processing module 324 may remain powered on during the idle process if the module 324 is performing filtering or other touch processing techniques.

If the touch screen subsystem 320 determines at decision block 520 that the filtered data represents an intentional touch event, the process 400 transitions to block 525 to calculate measurement data representing parameters of the touch event. In some embodiments, to calculate the measurement data, processing module 324 may configure touch detection module 322 to provide the coordinates of the detected touch so that processing module 324 may measure a plurality of parameters associated with the touch event. These parameters may comprise, for example, the pressure, direction, shape, start point, end point, and/or duration of the touch event.

After calculating the measurement data, the process then transitions to decision block 530 in which it determines whether an anchor-drag touch is identified by the measurement data. In some embodiments, this step may be performed by the touch processor 324 comparing the parameters of the touch event with anchor-drag touch parameters stored in a database such as gesture data store 330 of FIG. 3. Certain embodiments may accomplish the anchor-drag identification step 530 by the process 400 illustrated in FIG. 4. Step 530 may in some embodiments require the process 500 to recognize a first touch event representing an anchor touch, and to loop back to step 505 to detect a second touch event representing a drag touch.

If an anchor-drag gesture is identified at block 530, the process transitions to block 535 where the touch screen subsystem 320 identifies a function or information associated with the anchor-drag gesture and sends the function or information to the host processor 340 for execution. The function or information associated with the gesture may be stored in gesture data store 330 and accessed by processing module 324. In this way, the process 500 minimizes the use of the host processor 340 through the use of the anchor-drag gesture, restricting device host processing to merely performing the associated function on device 300 or displaying the associated information on display 310.

If the process 500 does not identify an anchor-drag gesture at block 530, the process 500 moves to block 540 where the touch screen subsystem 320 sends the measurement data to host processor 340. The process 500 then transitions to block 545 where host processor 340 performs traditional touch tracking. In response to host processor touch tracking, process 500 will transition to decision block 550 to determine whether any touch gesture was identified. If a touch gesture is not identified at block 550, the process 500 loops back to block 545 for the host processor to continue touch tracking. If after a certain period of time no touch event is identified, the process 500 may optionally loop back to block 505 to begin the touch screen subsystem idle process. If the process at block 550 determines a touch gesture other than an anchor-drag touch was identified, host processor 340 may execute a function associated with the touch gesture or display information associated with the touch gesture. The process 500 then loops back to block 505 to begin scanning for new touch events.

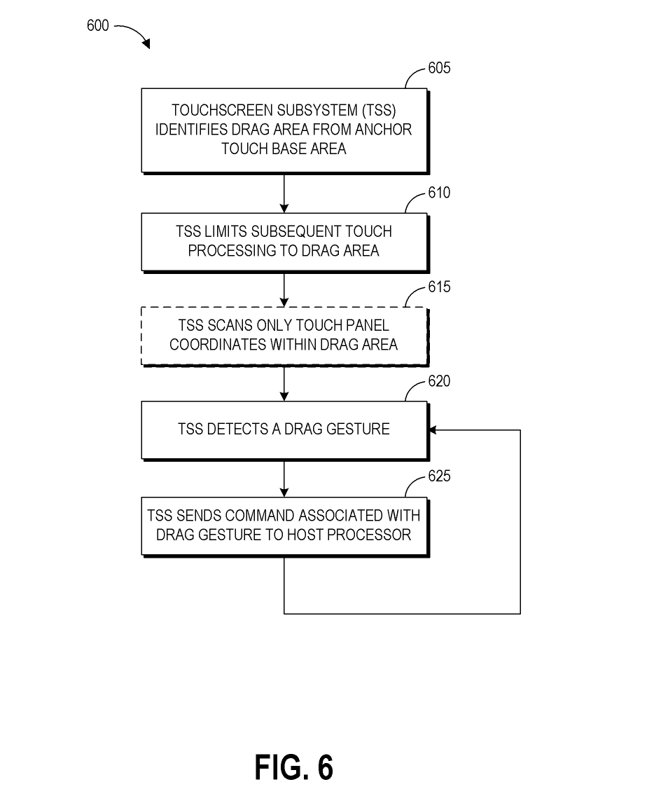

### VI. TOUCH PROCESSING LIMITATION (FIG. 6)

The process 600 illustrated in FIG. 6 is one embodiment of a touch processing limitation technique which may be carried out by touchscreen subsystem 320 of FIG. 3. Process 600 may also be incorporated, in some embodiments, as a sub process of touch processing process 500, for example after block 530 for identifying an anchor-drag gesture. In other embodiments, process 600 may employed for a period of time as follow-up process to process 400 for recognizing anchor-drag gestures in order to limit subsequent touch processing to the drag area.

The process begins at block 605 where the touch screen subsystem 320 identifies a drag area from a base area. This may be accomplished in a similar manner to the technique discussed above with respect to block 415 of process 400. With the drag area defined, the process 600 transitions to block 610, where the touch screen subsystem limits subsequent touch processing to the drag area for a time period referred to herein as a “drag gesture session.” This processing limitation allows a device user to perform a plurality of drag gestures within the drag area without performing additional anchor touches for each drag gesture. During a drag gesture session, touch events outside the drag area, as well as touch events within the drag area which are determined not to be valid drag gestures, are discarded.

Some embodiments of the process may optionally transition to block 615, in which the touch screen subsystem 320 limits all touch scanning to the touch panel coordinates within the boundary of the drag area. This differs from the processing limitation of step 610 in that touch events outside of the drag area are not just discarded, such events are never registered because the process 600 does not scan for touch events outside of the drag area.

The process 600 then transitions to block 620 in which the touch screen subsystem detects a drag gesture. In some embodiments, this step may be performed by the touch processor 324 comparing parameters of a touch event within the drag area—such as pressure, direction, shape, start point, end point, and/or duration of the touch event—with drag gesture parameters stored in a database such as gesture data store 330 of FIG. 3. After detecting a drag gesture, the process 600 transitions to block 625 in which a function or information set associated with the drag gesture is identified and sent to the host processor 340. The process then loops back to block 620 to perform the step of detecting an additional drag gesture, and will continue this loop for the duration of a drag gesture session.

The amount of time for which process 600 will loop between blocks 620 and 625 to maintain the drag gesture session may vary in different embodiments. For example, some embodiments may maintain a drag gesture session for the duration of use of a specific software program or application, while other embodiments may continue the drag gesture session until the user provides an indication that the drag gesture session is over. Yet other embodiments may continue the drag gesture session until determining that a predetermined time period has lapsed during which no drag gesture was made.

### VII. Terminology

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as a Pentium® processor, a Pentium® Pro processor, a 8051 processor, a MIPS® processor, a Power PC® processor, or an Alpha® processor. In addition, the processor may be any conventional special purpose processor such as touchscreen controller, a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as Linux®, UNIX® or Microsoft Windows®.

The system may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system may also be written using interpreted languages such as Perl, Python or Ruby.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A system configured to recognize multitouch gestures, the system comprising:
a touch panel;
a touch detection module configured to capture a first touch event and a second touch event on the touch panel; and
a processing module configured to determine if the second touch event is within a predefined boundary area from the first touch event, and discard the touch event if it is outside of the predefined boundary, the processing module further configured to track a position of a touch event within the predefined boundary and activate a predetermined object drag process based on the position of the touch event.

2. The system of claim 1, wherein the system is implemented in a mobile phone, a computer, or digital imaging device.

3. The system of claim 1, wherein the processing module comprises a touch screen subsystem having a touch screen controller.

4. The system of claim 1, wherein the touch panel comprises one of resistive, surface capacitive, projected capacitive, infrared, surface acoustic wave, strain gauge, optical imaging, or dispersive signal touch screen technologies

5. The system of claim 1, wherein the first touch is made by a first finger of a single hand and the second touch is made by a second finger of the single hand.

6. The system of claim 5, wherein the spatial relationship is based at least in part on Euclidean distance and angle between the first finger and the second finger.

7. The system of claim 1, wherein the second touch event comprises a geometric shape.

8. The system of claim 1, wherein the drag area occupies an area smaller than the touch panel.

9. A method of implementing a multitouch recognition function on a computing device equipped with a touch panel, the method comprising:
detecting a first touch event at a first location;
defining a base area on the touchscreen display based at least in part on the first location;
determining a drag area of the touch panel based at least in part on a predetermined geometric boundary in relation to the base area;
temporarily limiting subsequent touch processing on the touch panel to the drag area; and
detecting a second touch event within the drag area.

10. The method of claim 9, wherein the first touch is made by a first finger of a hand and the second touch is made by a second finger of the hand, and wherein determining a drag area further comprises estimating a Euclidean distance and angle between the first finger and the second finger.

11. The method of claim 9, wherein temporarily limiting subsequent touch processing on the touch panel to the drag area comprises discarding touch events located outside of the drag area.

12. The method of claim 9, further comprising determining a geometric shape of the second touch event.

13. The method of claim 12, further comprising associating a function with the geometric shape.

14. The method of claim 12, further comprising detecting a third touch event within the drag area, determining an additional geometric shape of the third touch event, and associating a function with the combination of the geometric shape and the additional geometric shape.

15. The method of claim 9, further comprising establishing a permanent drag area from the predetermined geometric boundary and limiting all subsequent touch processing to the permanent drag area for a duration of a predefined session.

16. A non-transitory computer-readable medium comprising code that, when executed, causes an processor to perform the method of:
detecting a first touch event;
defining a base area of the touchscreen display from the first touch event;
determining a drag area of the touchscreen display, the drag area being defined within a predetermined geometric boundary in relation to the base area;
temporarily limiting subsequent touch processing on the touchscreen to the drag area; and
detecting a second touch event within the drag area.

17. The non-transitory computer-readable medium of claim 16, wherein the first touch is made by a first finger of a hand and the second touch is made by a second finger of the hand, and wherein determining a drag area further comprises estimating a Euclidean distance and angle between the first finger and the second finger.

18. The non-transitory computer-readable medium of claim 16, wherein temporarily limiting subsequent touch processing on the touch panel to the drag area comprises discarding touch events located outside of the drag area.

19. The non-transitory computer-readable medium of claim 16, further comprising determining a geometric shape of the second touch event.

20. The non-transitory computer-readable medium of claim 19, further comprising associating a function with the geometric shape.

21. The non-transitory computer-readable medium of claim 19, further comprising detecting a third touch event within the drag area, determining an additional geometric shape of the third touch event, and associating a function with the combination of the geometric shape and the additional geometric shape.

22. The non-transitory computer-readable medium of claim 16, further comprising establishing a permanent drag area from the predetermined geometric boundary and limiting all subsequent touch processing to the permanent drag area for a duration of a predefined session.

23. An apparatus for multitouch recognition, comprising:
means for receiving touch data comprising a first touch event and a second touch event;
means for calculating a spatial relationship between a first location of the first touch event and a second location of the second touch event and establishing a drag area having geometric boundary in relation to the first location;
means for limiting subsequent touch processing to the drag area.

24. The apparatus of claim 23, wherein the first touch is made by a first finger of a single hand and the second touch is made by a second finger of the single hand.

25. The apparatus of claim 24, wherein the spatial relationship is based on Euclidean distance and angle between the first finger and the second finger

26. The apparatus of claim 23, wherein the means for receiving touch data comprises a touch panel.

27. The apparatus of claim 26, wherein the touch panel comprises one of resistive, surface capacitive, projected capacitive, infrared, surface acoustic wave, strain gauge, optical imaging, or dispersive signal touch screen technologies.

28. The apparatus of claim 23, wherein the means for calculating a spatial relationship comprises a touch screen subsystem having a touch screen controller

29. The apparatus of claim 23, wherein the means for limiting subsequent touch processing to the drag area comprises a touch screen subsystem having a touch screen controller.

30. The apparatus of claim 23, further comprising means for determining a geometric shape of the second touch.

31. The apparatus of claim 30, wherein the means for determining a geometric shape of the second touch comprises a touch screen subsystem having a touch screen controller.

32. The apparatus of claim 30, further comprising means for associating a function with the geometric shape.
